(19) United States
(12) Patent Application Publication
(10) Pub. No.: US 2014/0312015 A1
(43) Pub. Date: Oct. 23, 2014

(54) LASER PROCESSING APPARATUS, METHOD OF LASER PROCESSING, METHOD OF FABRICATING SUBSTRATE, AND METHOD OF FABRICATING INKJET HEAD

(71) Applicant: CANON KABUSHIKI KAISHA, Tokyo (JP)

(72) Inventors: Kosuke Kurachi, Yokohama-shi (JP); Hiroyuki Morimoto, Tokyo (JP)

(21) Appl. No.: 14/357,933

(22) PCT Filed: Nov. 7, 2012
(86) PCT No.: PCT/JP2012/007128

§ 371 Date: May 13, 2014

(30) Foreign Application Priority Data
Nov. 14, 2011 (JP) 2011-248382
Nov. 14, 2011 (JP) 2011-248383

(51) Int. Cl. B23K 26/38; B23K 26/06; B23K 26/067

(52) U.S. Cl. CPC B23K 26/388; B23K 26/067; B23K 26/0648
USPC 219/121.71; 219/121.77; 219/121.75

(57) ABSTRACT

In the case where the workpiece (1) is processed, the laser beam is S-polarized by an optical modulator (7). Thus, the laser beam is mainly diverted toward a workpiece (1) by a polarizer (6). An optical path through which the laser beam passes is caused to have a high light converging ability with respect to a target spot by an optical device (9). In the case where the workpiece (1) is not processed, the laser beam is P-polarized by the optical modulator (7). Thus, the laser beam is mainly diverted to a beam damper (10) side by the polarizer (6). However, the workpiece 1 is irradiated with the laser beam having leaked from the polarizer (6). An optical path through which the laser beam passes is caused to have a low light converging ability with respect to the target spot by the optical device (9).

### TECHNICAL FIELD

The present invention relates to a laser processing apparatus, which utilizes a laser beam to process a workpiece, a method of laser processing, a method of fabricating a substrate including laser processing steps, and a method of fabricating an inkjet head including laser processing steps.

### BACKGROUND ART

Laser beams are utilized for processing such as drilling, cutting, and welding in a variety of fields such as mechanical, electronic, and semiconductor fields. As an example of a laser processing apparatus with which such processing is performed, a technology in which a laser beam output from a laser oscillator is controlled by an electro-optic modulator and a polarization beam splitter so as to perform processing or stop processing is proposed (PTL 1).

According to the technology described in PTL 1, the direction of linear polarization of the laser beam is initially changed by the electro-optic modulator so as to selectively output the P-wave and the S-wave. After that, the polarization beam splitter splits an optical path into two optical paths, that is, an optical path through which the P-wave is mainly output and an optical path through which the S-wave is mainly output. Thus, by selecting the P-wave or the S-wave with the electro-optic modulator, an optical path after the polarization beam splitter is determined, and processing and stopping of processing is switched. In order to avoid unnecessary processing that is performed as a result of leakage of the laser beam to an unselected optical path, a plurality of the polarization beam splitters are provided.

### CITATION LIST

### Patent Literature

PTL 1: Japanese Patent Laid-Open No. 2003-126982

According to the technology described in the above-described PTL 1, the intensity of the laser beam having leaked is reduced by providing the plurality of polarization beam splitters. Thus, although unnecessary processing that is performed as a result of leakage of the laser beam, with which a workpiece is irradiated when processing is stopped, can be avoided, the intensity of the laser beam during processing is also reduced, thereby increasing energy losses.

The present invention is proposed in view of the above-described situation. The present invention is to avoid unnecessary processing that is performed as a result of leakage of a laser beam without increasing energy losses and to realize a structure with which processing is performed with high precision.

### SUMMARY OF INVENTION

According to the present invention, a laser processing apparatus includes a laser oscillator, a polarization direction switching member that switches a polarization direction of a laser beam emitted from the laser oscillator, a splitting member that splits the laser beam in accordance with the polarization direction having been switched by the polarization direction switching member, a light converging ability changing member that changes a light converging ability of the laser beam, the laser beam being split by the splitting member and directed to a workpiece, and a control unit that controls the polarization direction switching member and the light converging ability changing member in accordance with a state in which processing is being performed on the workpiece so as to cause the polarization direction of the laser beam directed to the workpiece to be switched and the light converging ability of the laser beam directed to the workpiece to be changed.

According to the present invention, the energy density of the laser beam at a target spot of the workpiece is variable by changing the light converging ability of the laser beam directed to the workpiece. Thus, without increasing energy losses, unnecessary processing that is performed as a result of leakage of the laser beam can be avoided, and high precision processing can be realized.

Further features of the present invention will become apparent from the following description of exemplary embodiments with reference to the attached drawings.

### BRIEF DESCRIPTION OF DRAWINGS

FIG. 1 is a schematic block diagram of a laser processing apparatus according to a first embodiment of the present invention.

FIG. 2 is a flowchart of laser processing steps according to the first embodiment.

FIG. 3 is a schematic block diagram of a laser processing apparatus according to a second embodiment of the present invention.

FIG. 4 is a flowchart of laser processing steps according to the second embodiment.

FIG. 5 is a schematic block diagram of a laser processing apparatus according to a third embodiment of the present invention.

FIG. 6 is a flowchart of laser processing steps according to the third embodiment.

FIG. 7 is a flowchart of the laser processing steps according to the third embodiment.

FIG. 8 is a sectional view of part of an inkjet head.

FIG. 9 is a schematic diagram illustrating a method of fabricating the inkjet head.

FIG. 10 is a schematic block diagram of a laser processing apparatus according to a fourth embodiment of the present invention.

FIG. 11 is a flowchart of laser processing steps according to the fourth embodiment.

### DESCRIPTION OF EMBODIMENTS

### First Embodiment

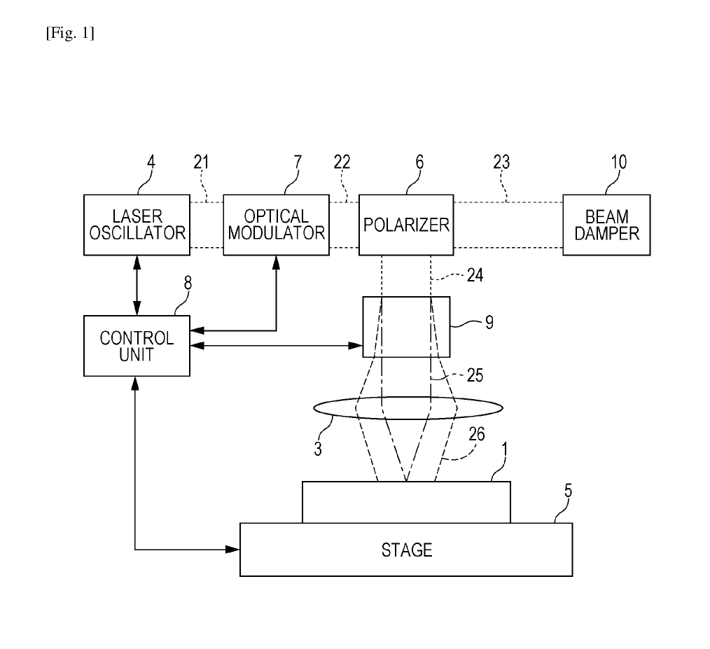

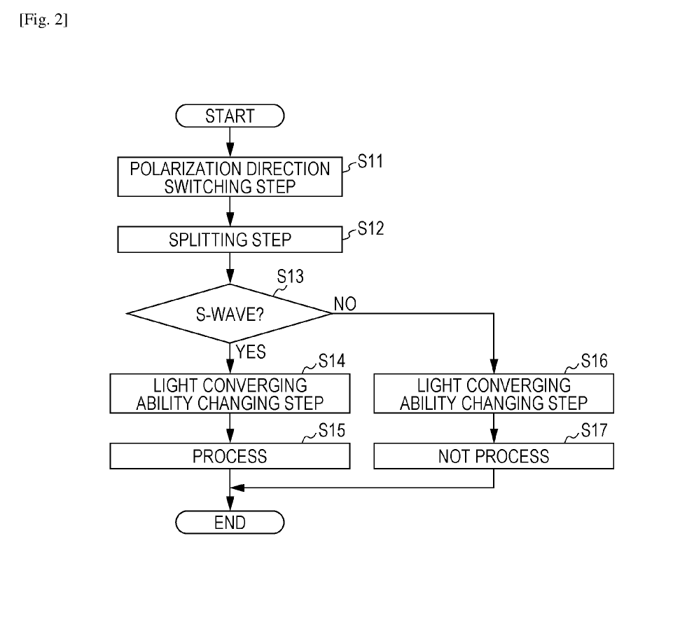

A first embodiment of the present invention will be described with reference to FIGS. 1 and 2. In the present embodiment, a laser processing apparatus, in which a laser beam is converged on a workpiece 1 as a material of a substrate so as to process part of the workpiece 1, is described. The substrate fabricated in the present embodiment is, for example, a semiconductor material substrate, a glass substrate, a piezoelectric material substrate, or the like.

The laser processing apparatus according to the present embodiment includes a laser oscillator 4, an optical modulator 7, a polarizer 6, an optical device 9, a condensing lens 3, a beam damper 10, a stage 5, and a control unit 8. The laser oscillator 4 uses a laser such as a YAG laser, a CO₂ laser, or an excimer laser. The laser oscillator 4 emits a linearly polarized laser beam 21 toward the optical modulator 7, which is described below.

The optical modulator 7 uses, for example, an electro-optic modulator (EOM) as a polarization direction switching member that switches the polarization direction of the laser beam 21 emitted from the laser oscillator 4. The optical modulator 7 changes the polarization direction of the laser beam 21 into either that of a P-wave as a second polarization direction or that of an S-wave as a first polarization direction in accordance with a control signal from the control unit 8, which will be described later. The laser beam, the polarization direction of which has been changed into that of the S-wave here, is referred to as a laser beam 22. The optical modulator 7 can respond faster than a pulse repeat frequency of the laser oscillator 4, and accordingly, can change the polarization direction of the laser beam 21 on a pulse-by-pulse basis in accordance with the control signal from the control unit 8.

The polarizer 6, which serves as a splitting member that splits a laser beam in accordance with the polarization direction switched by the optical modulator 7, uses, for example, a cubic polarization beam splitter, a plate-shaped polarization beam splitter, or the like. The polarizer 6 splits a beam into a laser beam 23, which is mainly composed of the P-wave, and a laser beam 24, which is mainly composed of the S-wave in accordance with the polarization direction of the laser beam 22. Herein, the laser beam with a main polarization is referred to as a laser main beam.

That is, the polarizer 6 cannot completely divert a laser beam in a direction and part of the laser beam unavoidably leaks. In the present embodiment, when the optical modulator 7 switches the polarization direction into the first polarization direction, that is, the polarization direction of the S-wave, the laser beam is mainly diverted to the optical device 9 side, which is a first diverting direction, and part of the laser beam leaks to the beam damper 10 side. The optical device 9 is described immediately below and the beam damper 10 is described later. In the case where the polarization direction is that of the P-wave, which is the second polarization direction, the laser beam is mainly diverted to the beam damper 10 side, which is a second diverting direction, and part of the beam leaks to the optical device 9 side. The part of the laser beam that leaks is referred to as a laser sub-beam.

The optical device 9 serves as a light converging ability changing member that changes the light converging ability of the laser beam 24, which is split by the polarizer 6 so as to be guided to the workpiece 1. The optical device 9 has the function of, for example, changing an optical path through which light transmitted therethrough passes. Such an optical device 9 uses, for example, an electro-optic modulator (refractive index modulator), which is formed of electrodes and an electro-optic material (dielectric material) and causes the refractive index of light passing therethrough to change in accordance with field intensity applied thereto. The optical device 9 can respond faster than the pulse repeat frequency of the laser oscillator 4, and accordingly, can change the light converging ability of light transmitted therethrough on a pulse-by-pulse basis in accordance with a control signal from the control unit 8.

Such an optical device 9 can change the optical path, through which the laser beam diverted in the first diverting direction by the polarizer 6 passes, to either of first and second optical paths. The first optical path can be, for example, an optical path having a high light converging ability with respect to a target spot of the workpiece 1, and the second optical path can be an optical path having a low light converging ability with respect to the target spot of the workpiece 1. Here, the optical path that has a high light converging ability with respect to the target spot, which is the first optical path, refers to an optical path through which the laser beam is converged on the target spot by the optical device 9. The optical path that has a low light converging ability with respect to the target spot, which is the second optical path, refers to an optical path through which the laser beam is not converged on the target spot by the optical device 9. Referring to FIG. 1, a laser beam 25 indicated by chain lines passes through the first optical path having a high light converging ability with respect to the target spot of the workpiece 1, and a laser beam 26 indicated by dashed lines passes through the second optical path having a low light converging ability with respect to the target spot of the workpiece 1.

It is sufficient that the optical device 9 change the light converging ability by changing the optical path. For example, instead of the above-described refractive index modulator, the optical device 9 may use a structure in which a lens is moved. That is, the optical path can be changed by moving a lens so as to change the position through which light is transmitted, and accordingly, the light converging ability can be changed.

The condensing lens 3 uses an optical system such as an optical system with which the laser beam 25 is converged on a fine spot, an optical system having a scanning mechanism, or an optical system having, for example, a combination of galvanometer scanner and an f-theta lens. The beam damper 10 absorbs the laser beam having been diverted in the second diverting direction by the polarizer 6. The workpiece 1 is positioned on and fastened to the stage 5, which moves the workpiece 1 in the XYZ-directions as desired.

The control unit 8 controls the laser oscillator 4, the stage 5, the optical modulator 7, and the optical device 9. The control unit 8 also controls the scanning mechanism of the condensing lens 3 in the case where the condensing lens 3 uses the optical system having the scanning mechanism.

Such a control unit 8 controls the optical modulator 7 and the optical device 9 in accordance with a processing state in which processing is performed on the workpiece 1, thereby switching the polarization direction of the laser beam directed to the workpiece 1 and changing the light converging ability. Specifically, a first mode and a second mode can be performed as follows. In the first mode, the polarization direction is switched to the first polarization direction by the optical modulator 7, and the optical device 9 is caused to become the first optical path having a high light converging ability with respect to the target spot. In the second mode, the polarization direction is switched to the second polarization direction by the optical modulator 7, and the optical device 9 is caused to become the second optical path having a low light converging ability with respect to the target spot.

That is, in the case where the workpiece 1 is processed, the control unit 8 controls the optical modulator 7 so as to switch the polarization direction of the laser beam to that of the S-wave. The S-wave is diverted to the optical device 9 side as the laser main beam by the polarizer 6. Here, the control unit 8 controls the optical device 9 so that the optical device 9 becomes the first optical path having a high light converging ability with respect to the target spot. By doing this, the workpiece 1 is processed.

In contrast, in the case where the workpiece 1 is not processed, the control unit 8 controls the optical modulator 7 so as to switch the polarization direction of the laser beam to that of the P-wave. The P-wave is diverted to the beam damper 10 side as the laser main beam by the polarizer 6. The optical device 9 is irradiated with the laser sub-beam having leaked from the polarizer 6. Here, the control unit 8 controls the optical device 9 so that the optical device 9 is set to be the second optical path, which is an optical path having a low light converging ability with respect to the target spot. By doing this, processing of the workpiece 1 with the light that has leaked can be suppressed.

Next, a laser processing steps according to the present embodiment are described with reference to FIG. 2. The laser oscillator 4 generates pulses of the laser beam 21 at a constant pulse repeat frequency. Since the pulses of the laser beam 21 are generated at a constant pulse repeat frequency, there is no variation in excitation time. Thus, the stability of laser light output is improved compared to a case in which the pulse repeat frequency is varied. The polarization direction of the laser beam 21 can be switched on a pulse-by-pulse basis by the optical modulator 7 in accordance with the control signal from the control unit 8. Thus, the laser beam 21 is converted to the laser beam 22, which is the P-wave or S-wave (polarization direction switching step; S11). With this control, which of the workpiece 1 and the beam damper 10 is to be irradiated with the laser beam having passed through the polarizer 6 can be determined on a pulse-by-pulse basis (splitting step; S12).

Here, in the case where the workpiece 1 is processed (first mode), the workpiece 1 is irradiated with the laser main beam; in the case where processing of the workpiece 1 is stopped (workpiece 1 is not processed), the beam damper 10 is irradiated with the laser main beam. However, depending on the performance of the polarizer 6 or optical effects produced between the optical modulator 7 and the polarizer 6, a situation in which only the workpiece 1 or only the beam damper 10 is irradiated with the laser beam cannot be caused. The workpiece 1 or the beam damper 10, which is not selected, is irradiated with the laser sub-beam having leaked. When the workpiece 1 is irradiated with the laser sub-beam having leaked at an energy density equal to or higher than a threshold value for processing the workpiece 1, the workpiece 1 is processed.

For this reason, in the case where the workpiece 1 is processed, the optical modulator 7 is controlled so that the workpiece 1 is irradiated with the laser main beam, and the optical device 9 is controlled so that the laser beam passes through the optical path having a high light converging ability (first optical path) with respect to the workpiece 1. In the present embodiment, when the laser beam has been changed to the S-wave (YES in S13) by the optical modulator 7, the laser beam is diverted to the optical device 9 side as the laser main beam by the polarizer 6. Here, the optical device 9 is controlled so that the laser beam passes through the optical path having a high light converging ability (first optical path) with respect to the workpiece 1 (light converging ability changing step; S14). Thus, the laser beam can be converged on the target spot of the workpiece 1 so as to process the workpiece 1 (S15).

In the case where processing of the workpiece 1 is stopped (workpiece 1 is not processed; second mode), the optical modulator 7 is controlled so that the beam damper 10 is irradiated with the laser main beam, and the optical device 9 is controlled so that the laser sub-beam passes through the optical path having a low light converging ability (second optical path) with respect to the workpiece 1. In the present embodiment, when the laser beam has been changed to the P-wave (NO in S13) by the optical modulator 7, the laser beam is diverted to the beam damper 10 side as the laser main beam by the polarizer 6, and the part of the laser sub-beam leaks to the optical device 9 side. Here, the optical device 9 is controlled so that the laser sub-beam passes through the optical path having a low light converging ability (second optical path) with respect to the workpiece 1 (light converging ability changing step; S16). Thus, the area by which the workpiece 1 is irradiated with the laser sub-beam having leaked is increased, and accordingly, the energy density can be equal to or smaller than the threshold value for processing the workpiece 1 (S17). These steps of processing of the workpiece 1, stopping of processing of the workpiece 1, and the movement of the workpiece 1 with the stage 5 are continued until desired processing performed on the workpiece 1 is completed, and then the processing is ended.

In the present embodiment, by changing the light converging ability of the laser beam directed to the workpiece 1 as described above, the energy density of the laser beam at the target spot of the workpiece 1 can be varied. Thus, unnecessary processing that is performed as a result of leakage of the laser sub-beam can be avoided without increasing energy losses.

That is, the optical path, through which the laser sub-beam leaking from the polarizer 6 when the workpiece 1 is not processed passes, is changed to an optical path having a low light converging ability (second optical path) with respect to the target spot by the optical device 9 (energy density is decreased). By doing this, processing of the workpiece 1 that is performed as a result of leakage of the laser sub-beam can be suppressed. In addition, need of providing a plurality of polarizers in order to avoid such unnecessary processing that is performed as a result of leakage of the laser sub-beam as described above is dropped, and the optical path, through which the laser main beam split by the polarizer 6 when the workpiece 1 is processed passes, is changed to an optical path having a high light converging ability (first optical path) with respect to the target spot by the optical device 9 (the energy density is increased). Thus, the energy loss of the laser main beam with which the workpiece 1 is irradiated is not increased.

In particular, when a wiring pattern or the like is formed in the workpiece 1, a portion that is easily processed by the laser is present in the workpiece 1 and the target spots are positioned on both sides of the easily processed portion, applying the present embodiment allows laser processing to be efficiently performed without processing the easily processed portion.

In addition, as is the case with the present embodiment, when the optical device 9 uses a refractive index modulator, the state of the optical device 9 for processing and not for processing can be quickly changed. Thus, in the case where the condensing lens 3 uses a galvanometer scanner or the like, the optical device 9 can be responsive to control of the scanner. The above-described relationship between the P-wave and S-wave may be inverted.

### Second Embodiment

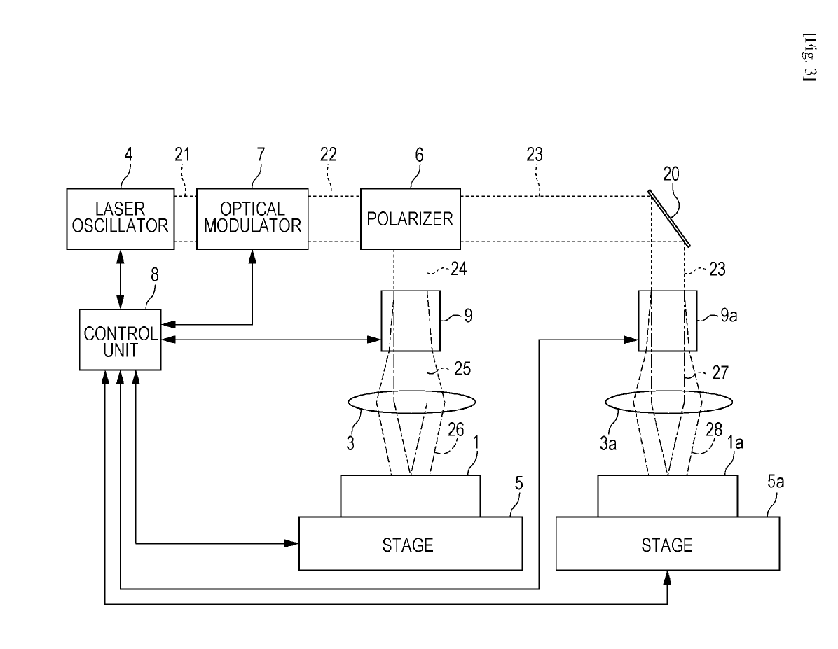

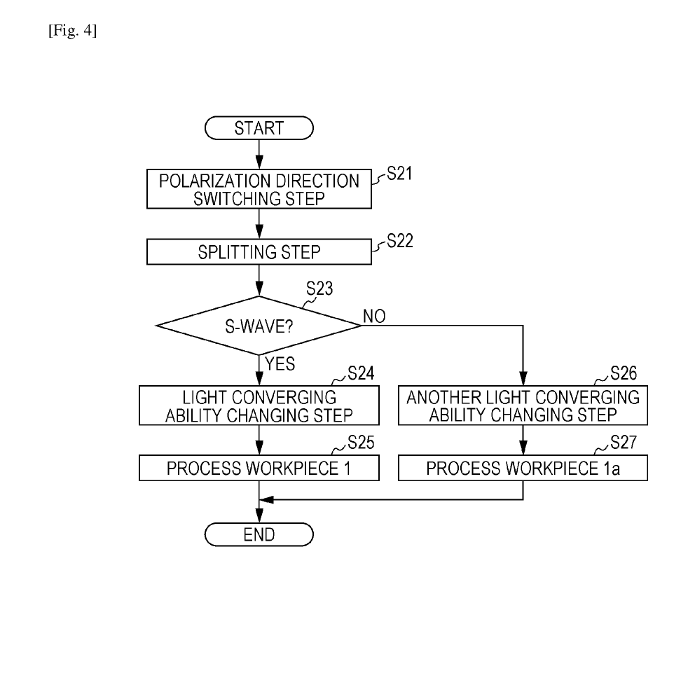

A second embodiment of the present invention is described with reference to FIGS. 3 and 4. In the above-described first embodiment, out of the laser beam split as the P-wave or the S-wave by the polarizer 6, part of the laser beam having leaked from the polarizer 6 is absorbed by the beam damper 10. In the present embodiment, such a beam having leaked is reflected by a mirror 20, so that another workpiece 1a is irradiated with the beam having leaked. The following description is mainly dedicated to part of the present embodiment different from the first embodiment and description duplicated with the first embodiment is omitted or simplified.

In the present embodiment, as described above, the mirror 20 that reflects the laser beam diverted in the second diverting direction by the polarizer 6 is provided. The mirror 20 uses, for example, a dielectric multilayer film mirror or a metallized mirror, thereby reflecting the laser beam so as to redirect the laser beam. There also is an optical device 9a that serves as another light converging ability changing member and is controlled by the control unit 8. The optical device 9a changes the optical path, through which the laser beam reflected by the mirror 20 passes, between an optical path having a high light converging ability with respect to a target spot of the workpiece 1a (first optical path) and an optical path having a low light converging ability (second optical path) with respect to the target spot of the workpiece 1a.

In the case of the present embodiment, the control unit 8 controls the optical device 9a such that, in the first mode, the optical device 9a is controlled to have a low light converging ability (second optical path) with respect to the target spot, and in the second mode, the optical device 9a is controlled to have a high light converging ability (first optical path) with respect to the target spot.

That is, in the case where the workpiece 1 is laser-processed, the laser beam is switched to the S-wave by the optical modulator 7 and the laser main beam is mainly directed to the optical device 9 on the workpiece 1 side by the polarizer 6. The laser sub-beam having leaked from the polarizer 6 is reflected by the mirror 20 and is directed to the optical device 9a. Thus, by making the optical device 9a an optical path having a low light converging ability (second optical path) with respect to the target spot, a situation in which the other workpiece 1a is processed is suppressed.

In contrast, in the case where the workpiece 1 is not laser-processed and the other workpiece 1a is laser-processed, the laser beam is switched to the P-wave by the optical modulator 7 and the laser main beam is mainly directed to the mirror 20 by the polarizer 6. This laser main beam is reflected by the mirror 20 so as to be directed to the optical device 9a. Thus, by making the optical device 9a an optical path having a high light converging ability (first optical path) with respect to the target spot, the other workpiece 1a is processed.

Here, as is the case with the workpiece 1, the other workpiece 1a is processed to be a material of a substrate. The workpiece 1 and the workpiece 1a may be the same member. That is, portions of a single workpiece at positions different from each other may be separately processed.

The optical device 9a is similar to the optical device 9, and a condensing lens 3a is similar to the condensing lens 3. A stage 5a is similar to the stage 5. When the workpiece 1 and the workpiece 1a are a single member, the stage 5a and the stage 5 are the same single component. The control unit 8 also controls the optical device 9a and the stage 5a. In addition, as is the case with the laser beam 25, the optical path, through which a laser beam 27 indicated by chain lines in FIG. 3 passes, has a high light converging ability (first optical path) with respect to the target spot of the workpiece 1, and, as is the case with the laser beam 26, the optical path, through which a laser beam 28 indicated by dashed lines in FIG. 3 passes, has a low light converging ability (second optical path) with respect to the target spot of the workpiece 1.

Next, a laser processing steps according to the present embodiment is described with reference to FIG. 4. The laser oscillator 4 generates pulses of the laser beam 21 at a constant pulse repeat frequency. The polarization direction of the laser beam 21 can be switched by the optical modulator 7 in accordance with the control signal from the control unit 8 on a pulse-by-pulse basis. Thus, the laser beam 21 is converted to the laser beam 22, which is the P-wave or S-wave (polarization direction switching process; S21). With this control, which of the workpiece 1 and the other workpiece 1a is to be irradiated with the laser beam having passed through the polarizer 6 can be determined on a pulse-by-pulse basis (splitting step; S22).

Here, in the case where the workpiece 1 is processed (first mode), the workpiece 1 is irradiated with the laser main beam; in the case where the other workpiece 1a is processed, the workpiece 1a is irradiated with the laser main beam. However, depending on the performance of the polarizer 6 or optical effects produced between the optical modulator 7 and the polarizer 6, a situation in which only the workpiece 1 or only the other workpiece 1a is irradiated with the laser beam cannot be caused. The workpiece 1 or the other workpiece 1a, which is not selected, is irradiated with the laser sub-beam having leaked. When the workpiece 1 or 1a is irradiated with the laser sub-beam having leaked at the energy density equal to or higher than the threshold value for processing the workpiece 1 or 1a, the workpiece 1 or 1a is processed.

For this reason, in the case where the workpiece 1 is processed, the optical modulator 7 is controlled so that the workpiece 1 is irradiated with the laser main beam, and the optical device 9 is controlled so that the laser beam, with which the workpiece 1 is irradiated, passes through the optical path having a high light converging ability (first optical path) with respect to the workpiece 1. At the same time, the optical device 9a is controlled so that the laser sub-beam having leaked, with which the other workpiece 1a is irradiated, passes through the optical path having a low light converging ability (second optical path) with respect to the target spot.

In the present embodiment, when the laser beam has been changed to the S-wave (YES in S23) by the optical modulator 7, the laser beam is diverted to the workpiece 1 side as the laser main beam by the polarizer 6. Here, the optical device 9 is controlled so that the laser main beam passes through the optical path having a high light converging ability (first optical path) with respect to the workpiece 1 (light converging ability changing step; S24). The laser sub-beam having leaked from the polarizer 6 is reflected by the mirror 20 so as to be directed to the other workpiece 1a. Here, the optical device 9a is controlled so that the laser sub-beam passes through the optical path having a low light converging ability (second optical path) with respect to the other workpiece 1a (the other light converging ability changing step). Thus, the laser main beam is converged on the workpiece 1 so that the workpiece 1 can be processed, and at the same time, unnecessary processing of the other workpiece 1a that is performed as a result of leakage of the laser sub-beam can be avoided (S25).

In the case where the workpiece 1a is processed (second mode), the optical modulator 7 is controlled so that the workpiece 1a is irradiated with the laser main beam, and the optical device 9a is controlled so that the laser main beam, with which the workpiece 1a is irradiated, passes through the optical path having a high light converging ability (first optical path) with respect to the target spot. At the same time, the optical device 9 is controlled so that the laser sub-beam having leaked, with which the workpiece 1 is irradiated, passes through the optical path having a low light converging ability (second optical path) with respect to the target spot.

In the present embodiment, when the laser beam has been changed to the P-wave (NO in S23) by the optical modulator 7, the laser beam is diverted to the mirror 20 side as the laser main beam by the polarizer 6 and reflected by the mirror 20 so that the other workpiece 1a is irradiated with this reflected laser beam. Here, the optical device 9a is controlled so that the laser main beam passes through the optical path having a high light converging ability (first optical path) with respect to the other workpiece 1a (the other light converging ability changing step; S26). The workpiece 1a is irradiated with the laser sub-beam having leaked from the polarizer 6. Here, the optical device 9 is controlled so that the laser sub-beam passes through the optical path having a low light converging ability (second optical path) with respect to the workpiece 1 (light converging ability changing step). Thus, the laser main beam is converged on the other workpiece 1a so that the other workpiece 1a can be processed, and, at the same time, unnecessary processing of the workpiece 1 that is performed as a result of leakage of the laser sub-beam can be avoided (S27). Such switching of a target to be processed and the movement of the workpieces 1 and 1a with the stages 5 and 5a are continued until desired processing performing on the workpieces 1 and 1a is completed, and then the processing is ended.

In the present embodiment, by switching the target to be processed as described above, as is the case with the first embodiment, unnecessary processing that is performed as a result of leakage of the laser sub-beam can be avoided without increasing energy losses.

In the above description, the workpieces are positioned on the respective stages. However, a plurality of workpieces can be positioned on a single stage. With respect to switching for processing, instead of switching the workpiece to be irradiated with the laser beam, target spots on a single workpiece can be switched. Other structures and operations are similar to those of the aforementioned first embodiment.

### Third Embodiment

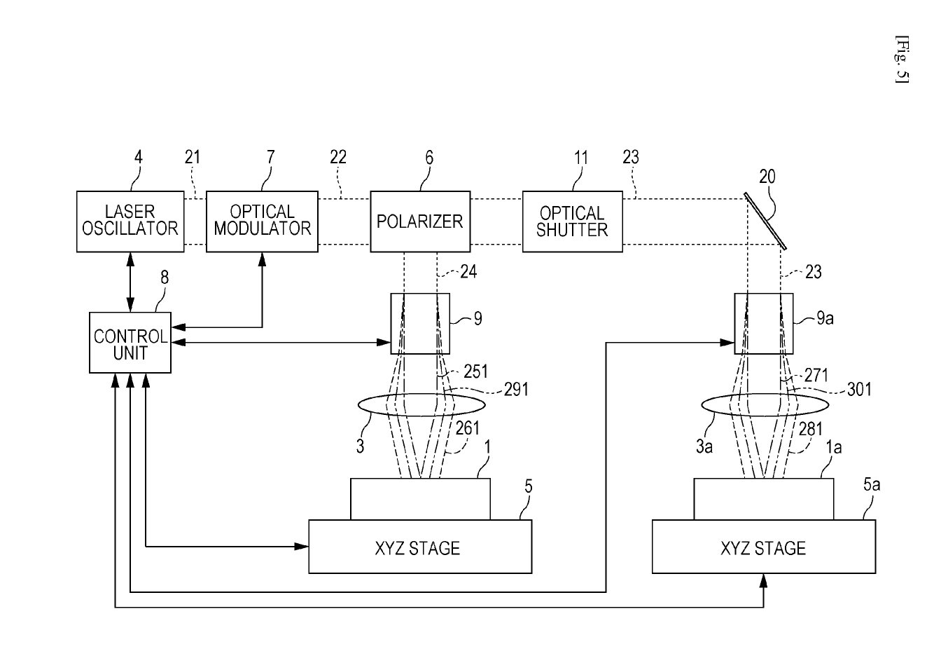

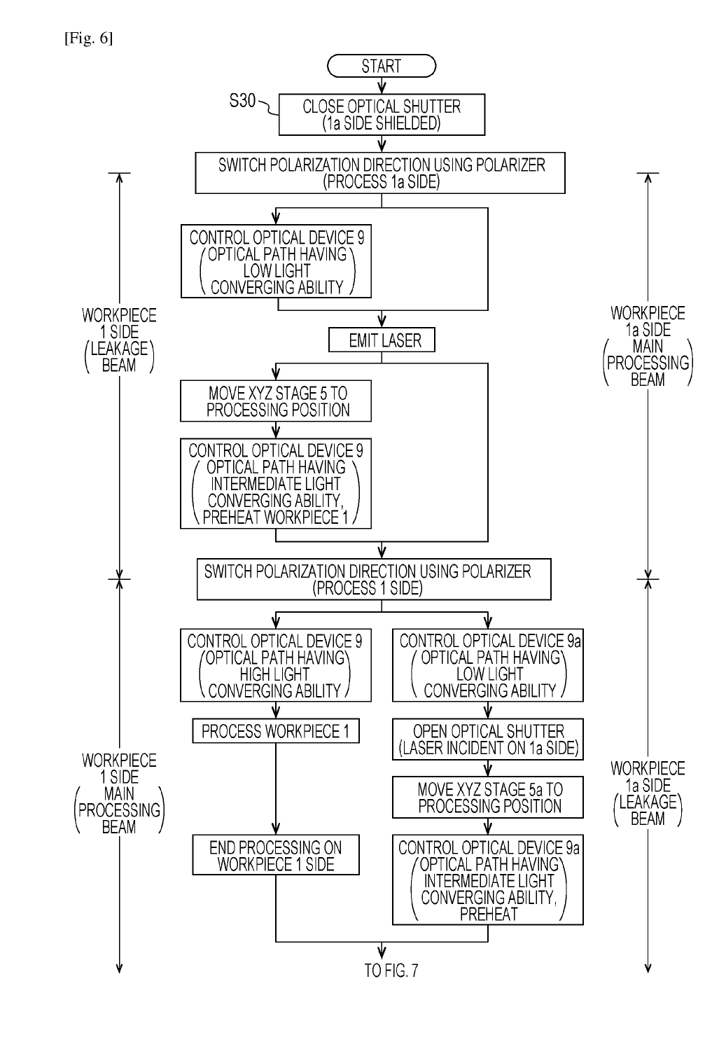

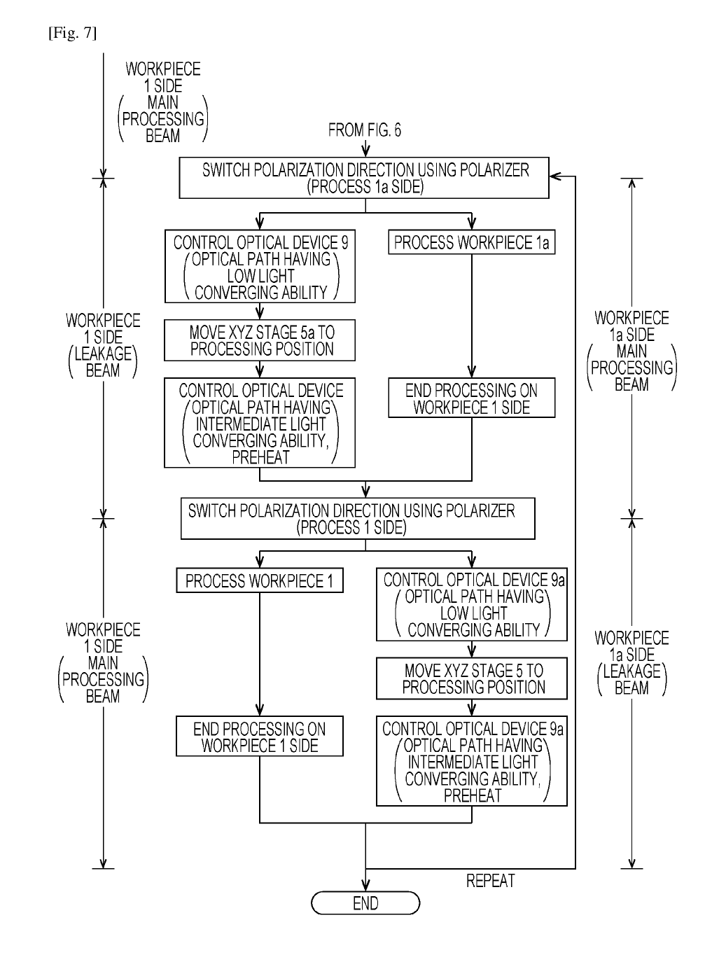

A third embodiment of the present invention is described with reference to FIGS. 5, 6 and 7.

A laser processing apparatus according to the present embodiment includes the laser oscillator 4, the optical modulator 7, the polarizer 6, the optical devices 9 and 9a, the condensing lenses 3 and 3a, an optical shutter 11, a folding mirror 20, the stages 5 and 5a, and the control unit 8. The laser beam 21 is a laser beam emitted from the laser oscillator 4, the laser beam 22 is a laser beam transmitted through the optical modulator 7, and the laser beams 23 and 24 are laser beams split by the polarizer 6.

In addition to the optical paths having a high light converging ability (first optical path) and the optical paths having a low light converging ability (second optical path) described above in the second embodiment, a workpiece is irradiated with a laser beam passing through optical paths having an intermediate light converging ability (third optical path). The following description is mainly dedicated to part of the present embodiment different from the second embodiment and description duplicated with the second embodiment is omitted or simplified.

In the present embodiment, the optical devices 9 and 9a can change the optical paths into optical paths having an intermediate light converging ability 291 and 301 (third optical paths) in addition to changing the optical paths into optical paths having a high light converging ability 251 and 271 (first optical paths) and optical paths having a low light converging ability 261 and 281 (second optical paths).

Here, when the optical devices 9 and 9a are adjusted to converge light so that the energy densities of the laser beams are from 70% to 90% with respect to the threshold values for processing the workpieces, this light converging ability is referred to as an intermediate light converging ability. The threshold value for processing refers to a boundary energy density equal to or greater than a specified energy density at which, when the laser beam is converged on a workpiece, processing of the workpiece starts. The threshold value for processing is determined in accordance with the physical properties and temperature of the workpiece and conditions under which the workpiece is irradiated with the laser beam. For example, when the workpiece is formed of a silicon material, the wavelength of the laser beam is 532 nm, the pulse width of the laser beam is about 12 psec, the energy density of the threshold value for processing is about 1 J/cm².

In laser processing, processing is performed at an energy density slightly greater than the threshold value for processing, thereby allowing effects of heat affecting an area around a processed portion to be minimized. However, immediately after the start of processing, the temperature of part of the workpiece irradiated with the laser beam is suddenly changed, and accordingly, processing precision becomes unstable. By preheating the part of the workpiece to be irradiated with the laser beam at an energy density from 70% to 90% with respect to the threshold value for processing, temperature changes of the workpiece can be reduced, and accordingly, processing precision immediately after the start of processing can be improved.

Regarding conditions under which the silicon material is processed, when the energy density is about 0.90 J/cm², the workpiece is not processed and processing precision immediately after the start of processing can be improved. However, when the energy density is decreased below about 0.70 J/cm², processing precision is decreased. In the case where the energy density exceeds 0.90 J/cm² and equal to or smaller than the threshold value for processing, the workpiece may be unintentionally processed depending on the state in which the surface of the workpiece is processed. Thus, the energy density is preferably about 0.90 J/cm² or smaller.

Next, a laser processing steps according to the present embodiment are described with reference to FIGS. 5, 6, and 7. At the start of processing, the laser oscillator 4 is not yet driven and the laser beam is not emitted. In addition, the optical shutter 11 is closed, thereby shielding the workpiece 1a side from radiation by the laser beam. Next, the laser processing apparatus is set in a state in which, when the laser beam is polarized to the S-wave by the optical modulator 7, the laser beam is diverted to the workpiece 1a side as the laser main beam by the polarizer 6. The optical device 9 is controlled so that the optical path through which the laser sub-beam passes, the laser sub-beam being a beam with which the workpiece 1 is irradiated, is the optical path having a low light converging ability (second optical path) 261. Next, the laser oscillator 4 is driven so as to emit the laser beam. By polarizing the laser beam to the S-wave by the optical modulator 7 and causing the laser right to be incident upon the polarizer 6, the laser sub-beam having leaked is incident upon the workpiece 1. However, because of the low light converging ability, the workpiece 1 is not processed. Next, the XYZ stage 5 is moved to a processing position. Then, the optical device 9 is controlled so that the optical path becomes the optical path having an intermediate light converging ability (third optical path) 291 so as to preheat the workpiece 1. During the above-described process, the laser main beam in not incident upon the workpiece 1a side because the optical shutter 11 is closed.

Next, the polarizer 6 is switched so as to cause the laser main beam to be incident upon the workpiece 1 side, and at the same time, the optical device 9 is controlled so that the optical path becomes the optical path having a high light converging ability (first optical path) 251. Thus, processing with high precision is started due to the effects produced by the above-described preheat. Also at the same time, the optical device 9a is controlled so that the optical path becomes the optical path having a low light converging ability (second optical path) 281. Next, the optical shutter 11 is opened. At this time, although the laser sub-beam having leaked from the polarizer 6 is incident upon the workpiece 1a side, the workpiece 1a is not processed due to the low light converging ability. Next, the XYZ stage 5a is moved to a processing position. Next, the optical device 9a is controlled so that the optical path becomes the optical path having an intermediate light converging ability (third optical path) 301 so as to preheat the workpiece 1a. During the above-described steps for the workpiece 1a, processing advances on the workpiece 1 and ends after a certain period of time has passed.

Next, the polarizer 6 is switched so as to cause the laser main beam to be incident upon the workpiece 1a side, and at the same time, the optical device 9a is controlled so that the optical path becomes the optical path having a high light converging ability (first optical path) 271. Thus, processing with high precision is started due to the above-described preheat. Also at the same time, the optical device 9 is controlled so that the optical path on the workpiece 1 side is the optical path having a low light converging ability (second optical path) 261. Although the laser sub-beam having leaked is incident upon the workpiece 1 side, the workpiece 1 is not processed due to the low light converging ability. Next, the XYZ stage 5 is moved to a processing position. Next, the optical device 9 is controlled so that the optical path becomes the optical path having an intermediate light converging ability (third optical path) 291 so as to preheat the workpiece 1. During the above-described steps for the workpiece 1, processing advances on the workpiece 1a and ends after a certain period of time has passed.

The above-described steps are repeated and processing finally ends.

By performing the above-described steps, positioning and preheat for one of the workpieces can be completed while the other workpiece is processed with the laser main beam. Thus, as is the case with the second embodiment, unnecessary processing that is performed as a result of leakage of the laser sub-beam can be avoided without increasing energy losses. In addition, processing with high precision can be realized due to preheating.

In general, a workpiece is not necessarily formed of a single material; sometimes a workpiece is formed of a plurality of materials having respective threshold values for processing largely different from one another. In such a case, under the energy density conditions for an intermediate light converging ability set for a workpiece, for which the threshold value for processing is high, a workpiece for which the threshold value for processing is low is unnecessarily processed. For such a workpiece, it is more effective that, as described in the present embodiment, the optical path having a high light converging ability (first optical path), the optical path having a low light converging ability (second optical path), and the optical path having an intermediate light converging ability (third optical path) be provided.

However, when the workpiece is formed of a single material, by using the method described in the second embodiment and by changing the optical path having a low light converging ability (second optical path) described in the second embodiment into the optical path having an intermediate light converging ability (third optical path) described in the present embodiment, processing with high precision can be realized more easily in a method of utilizing preheat.

Although the laser sub-beam is described as a laser beam that have leaked in the above-described embodiments, a specified amount of laser beam can be intentionally leaked by adjusting the polarizer 6 so as to obtain the laser sub-beam, thereby realizing the energy density of the intermediate light converging ability.

Other structures and operations are similar to those of the aforementioned second embodiment.

Substrates fabricated by the laser processing apparatus and the method of processing with the laser described in the aforementioned embodiments are used as substrates such as substrates of inkjet heads, other semiconductor material substrates, glass substrates, and circuit substrates. Processing is not limited to drilling holes such as leading holes. Processing can include processing of groove shapes, cutting, modification, welding, and so forth. Specific application is not limited to drilling of leading holes of inkjet heads. For example, the processing can be applied to drilling of circuit substrates, scribing of solar cell substrates, trimming of register components, seal-welding of battery cases, and so forth.

### Fourth Embodiment

Next, a fourth embodiment is described. In the fourth embodiment, a position irradiated with the laser beam is changed.

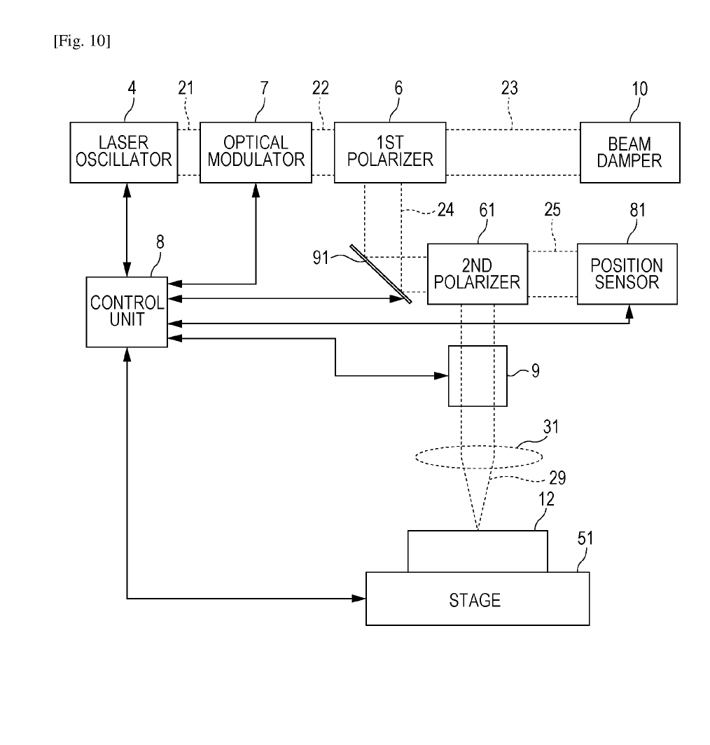

FIG. 10 illustrates the fourth embodiment. The following description is mainly dedicated to part of the present embodiment different from the first embodiment and description duplicated with the first embodiment is omitted or simplified. A second polarizer 61 and a position sensor 81 are disposed in an optical path of the laser beam between a first polarizer 6 (polarizer of the first embodiment) and the condensing lens 3.

The first polarizer 6 and the second polarizer 61 respectively serve as a first splitting member and a second splitting member that split the laser beam in accordance with the polarization direction switched by the optical modulator 7. The first polarizer 6 and the second polarizer 61 as described above each may use, for example, a cubic polarization beam splitter, a plate-shaped polarization beam splitter, or the like.

The first polarizer 6 and the second polarizer 61 can have the same characteristics with respect to the polarization extinction ratio, which represents the ratio by which a laser beam incident upon a polarizer is mainly split in accordance with the polarization direction. In the present embodiment, it is assumed that the optical characteristics with which the first polarizer 6 and the second polarizer 61 each reflect and transmit the laser beam, are as follows: for P-polarization, transmittance of about 99% and reflectance of about 1%; for S-polarization, transmittance of about 1% and reflectance of about 99%.

The first polarizer 6 serving as the first splitting member splits the laser beam in accordance with the polarization direction of the laser beam 22 (first splitting step). In other words, the laser beam 23 transmitted through the first polarizer 6 and the laser beam 24 reflected by the first polarizer 6 are output.

That is, the first polarizer 6 cannot completely divert the laser beam in a direction and part of the laser beam unavoidably leaks. First, a case, in which the polarization direction switched by the optical modulator 7 is the first polarization direction, that is, the S-wave, is described. As the laser main beam, 99% of the laser beam is reflected to the second polarizer 61 side, which is a first split optical path. As the laser sub-beam, 1% of the laser beam is transmitted to the beam damper 10 side, which is a second split optical path. In contrast, in the case of the P-wave as the second polarization direction, as the laser main beam, 99% of the laser beam is transmitted to the beam damper 10 side, which is the second split optical path, and as the laser sub-beam, 1% of the laser beam is reflected to the second polarizer 61 side, which is the first split optical path.

The laser beam 24 is incident upon the second polarizer 61, which is positioned in the first split optical path. The second polarizer 61 splits the laser beam in accordance with the polarization direction of the laser beam 22 (second splitting step). In other words, the laser beam 25 transmitted through the second polarizer 61 and a laser beam 29 reflected by the second polarizer 61 are output.

That is, as is the case with the first polarizer 6, the second polarizer 61 cannot completely divert a laser beam in a direction and part of the laser beam unavoidably leaks. First, a case, in which the polarization direction switched by the optical modulator 7 is the S-wave, is described. As the laser main beam, 99% of the laser beam is reflected to the workpiece side and as the laser sub-beam, 1% of the laser beam is transmitted to the position sensor 81 side. In contrast, when the polarization direction is the P-wave, as the laser main beam, 99% of the laser beam is transmitted to the position sensor 81 side, and as the laser sub-beam, 1% of the laser beam is reflected to a workpiece 12 side.

The position sensor 81 detects the position of the laser beam emitted from the laser oscillator 4. The position sensor 81 includes, for example, a position sensitive detector (PSD), a neutral density (ND) filter, a lens, and the like. The position sensor 81 detects changes in position and angle of the laser beam 25 having been transmitted through the second polarizer 61. A detected output signal is sent to the control unit 8 and is subjected to signal processing such as integration so as to be used as position data of the laser beam. The position sensor 81 can detect the laser beam, the intensity of which is preferably within, for example, a range of plus or minus 10% of a set intensity.

The optical device 9 (light converging ability changing member) may be used as an unit configured to change an irradiation position that changes a position on the workpiece 12 to be irradiated with the laser beam in accordance with a result of detection performed by the position sensor 81. That is, by changing an optical path through a change in refractive index, a position irradiated with the laser may be changed. Such a light converging ability changing member, which can change the refractive index, uses, for example, an electro-optic modulator (refractive index modulator), which is formed of electrodes and an electro-optic material (dielectric material) and causes the refractive index of light passing therethrough to change in accordance with field intensity applied thereto.

The unit configured to change an irradiation position may also use, for example, a movable mirror 91 other than the optical device 9. A single mirror 91 or a plurality of mirrors 91 may be provided. The mirror 91 may use, for example, a dielectric multilayer film mirror or a metallized mirror. The position or the angle of the mirror 91 may be changed using a piezoelectric element, a stepping motor, or the like, thereby changing the optical path of light reflected by the mirror 91. when a single mirror 91 is provided, not only the angle but also the position of the mirror may be changed. When the plurality of mirrors 91 are provided, the position to be irradiated with the laser beam may be changed by changing the angle of each mirror 91.

Furthermore, as the unit configured to change an irradiation position, a condensing lens 31 may be moved. That is, the optical path can be changed by moving the condensing lens 31 so as to change the position through which light is transmitted. The condensing lens 31 may use an optical system such as an optical system with which the laser beam is converged on a fine spot, an optical system having a scanning mechanism, or an optical system having, for example, a combination of a galvanometer scanner and an f-theta lens.

The position on the workpiece 12 to be irradiated with the laser beam may be changed through at least one or combination of a plurality of units configured to change an irradiation position including: a unit configured to change the light converging ability of the light converging ability changing member 9, a unit configured to move the mirror 91, and a unit configured to move the condensing lens 31.

The beam damper 10 absorbs one of the laser beams having been split by the first polarizer 6. A stage 51 may move the workpiece 12 in the XYZ-directions as desired.

The control unit 8 controls the laser oscillator 4, the stage 51, the optical modulator 7, and the position sensor 81, and also controls the unit configured to change an irradiation position. The unit configured to change an irradiation position controls at least one of, for example, the following: a movement of the mirror 91, changing field intensity or the like applied to the light converging ability changing member (optical device) 9 so as to change the light converging ability, and a movement of the condensing lens 31 with the scanning mechanism (not shown) or the like.

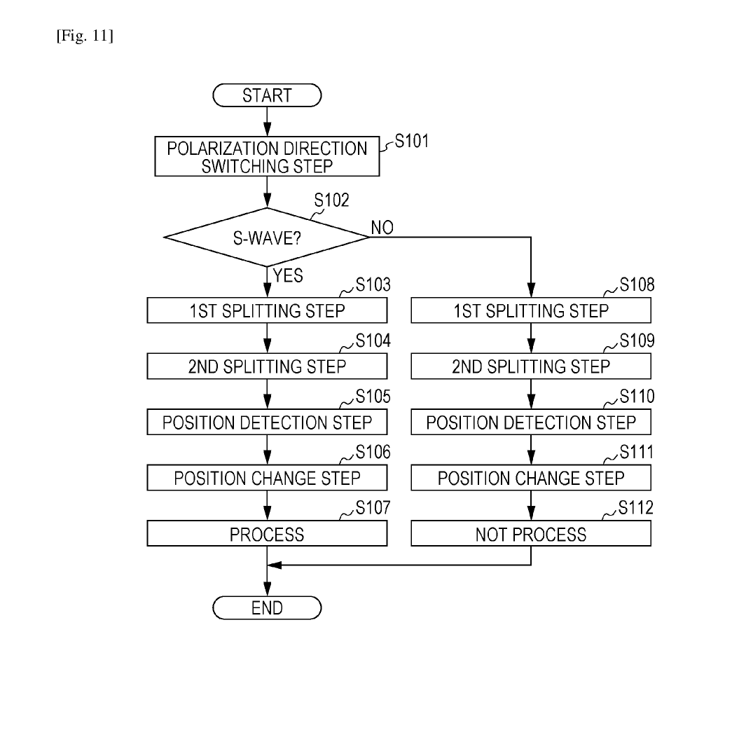

Next, a laser processing steps according to the present embodiment are described with reference to FIGS. 10 and 11. The laser oscillator 4 generates pulses of the laser beam 21 at a constant repetition frequency. The polarization direction of the laser beam 21 can be switched on a pulse-by-pulse basis by the optical modulator 7. Thus, the laser beam 22 of P-wave or S-wave is selectively output (polarization direction switching step; S101).

Here, in the case where the workpiece 12 is processed, the workpiece 12 is irradiated with the laser beam; in the case where processing of the workpiece 12 is stopped (workpiece 12 is not processed), the beam damper 10 is irradiated with the laser beam. Thus, in the case where the workpiece 12 is processed, the optical modulator 7 is controlled so that the workpiece 12 is irradiated with the laser beam. In the present embodiment, when the laser beam has been changed to the S-wave (YES in S102) by the optical modulator 7, the laser beam is diverted to the mirror 91 side as the laser main beam by the first polarizer 6 (first splitting step; S103).

In the present embodiment, since about 1% of energy is lost when the laser beam is transmitted through the optical modulator 7, the intensity of the laser beam 22 having been transmitted through the optical modulator 7 is about 99% of that of the laser beam 21. This laser beam 22 having been transmitted through the optical modulator 7 is then introduced into the first polarizer 6.

As described above, the optical characteristics with which the first polarizer 6 reflects and transmits the laser beam are as follows: for P-polarization, transmittance of about 99% and reflectance of about 1%; for S-polarization, transmittance of about 1% and reflectance of about 99%. Thus, which of the workpiece 12 and the beam damper 10 is to be irradiated with the laser main beam having passed through the first polarizer 6 can be determined on a pulse-by-pulse basis using control of the polarization direction performed by the optical modulator 7 and the first polarizer 6.

In the case where the workpiece 12 is processed, as described above, it is selected that the laser beam transmitted through the optical modulator 7 is the S-wave. Thus, about 1% of the laser beam 22 is transmitted through the first polarizer 6, and the beam damper 10 is irradiated with the laser beam having been transmitted through the first polarizer 6. About 99% of the laser beam 22 is reflected by the first polarizer 6 and the movable mirror 91 so as to be introduced into the second polarizer 61.

As described above, as is the case with the first polarizer 6, the optical characteristics with which the second polarizer 61 reflects and transmits the laser beam are as follows: for P-polarization, transmittance of about 99% and reflectance of about 1%; for S-polarization, transmittance of about 1% and reflectance of about 99% (second splitting step; S104). At this time, since the laser beam introduced into the second polarizer 61 is the S-polarization, the intensity of the laser beam 25 having been transmitted through the second polarizer 61 is about 1% of that of the laser beam 24 introduced into the second polarizer 61. The laser beam 25 of such intensity is incident upon the position sensor 81.

In other words, with reference to the laser beam 21, the intensity of the laser beam 25 is about 0.98% (=99%×99%×1%) of that of the laser beam 21. The position sensor 81 is preset using an ND filter, a lens, and the like so that the position sensor 81 can detect changes in position and angle of the laser beam, the intensity of which is about 0.98% of that of the laser beam 21. The position sensor 81, when the laser beam 25 having such an intensity is incident thereupon, detects changes in position and angle of the laser beam 25 (position detection step; S105).

For example, the refractive index of the optical device 9 is changed or the mirror 91 is moved by the control unit 8 so that the position of the laser beam 25 in the position sensor 81 is aligned with a specified position. That is, the position on the workpiece 12 to be irradiated with the laser beam is changed in accordance with the result of detection performed by the position sensor 81 in the position detection step (position change step; S106). Thus, the position of the laser beam can be automatically adjusted during processing, thereby improving precision of the position on the workpiece 12 to be irradiated with the laser beam.

The intensity of the laser beam 29, which has been reflected by the second polarizer 61, is about 99% of that of the laser beam introduced into the second polarizer 61. In other words, with reference to the laser beam 21, the intensity of the laser beam 29, which has been reflected by the second polarizer 61, is about 97.03% (=99%×99%×99%) of that of the laser beam 21. The workpiece 12 is irradiated with the laser beam 29 having been reflected by the second polarizer 61 and passed through the condensing lens 31, and the workpiece 12 is processed (S107).

Next, stopping of processing (not processing), which is performed at such time as when the workpiece 12 has been processed into a desired shape or when the workpiece 12 is moved to the next target spot, is described. In order to stop processing, it is selected that the laser beam transmitted through the optical modulator 7 is the P-polarization (S101, NO in S102).

Thus, about 99% of the laser beam 22 is transmitted through the first polarizer 6, and the beam damper 10 is irradiated with the laser beam having been transmitted through first polarizer 6 (first splitting step; S108). About 1% of the laser beam 22 is reflected by the first polarizer 6 and the movable mirror 91 so as to be introduced into the second polarizer 61.

Since the laser beam introduced into the second polarizer 61 is the P-polarization, the intensity of the laser beam 25 having been transmitted through the second polarizer 61 is about 99% of that of the laser beam introduced into the second polarizer 61. This laser beam 25 having an intensity of 99% is incident upon the position sensor 81 (second splitting step; S109). In other words, with reference to the laser beam 21, the intensity of the laser beam 25, which has been transmitted through the second polarizer 61, is about 0.98% (=99%×1%×99%) of that of the laser beam 21.

As described above, the position sensor 81 is preset using an optical system including an ND filter and a lens so that the position sensor 81 can detect changes in position and angle of the laser beam, the intensity of which is 0.98% of that of the laser beam 21. Thus, while processing is stopped, the position sensor detects changes in position and angle of the laser beam 25 as in the case where processing is performed (position detection step; S110).

For example, the refractive index of the optical device 9 is changed or the mirror 91 is moved by the control unit 8 so that the position of the laser beam 25 in the position sensor 81 is aligned with a specified position (position change step; S111). By doing this, control of the position to be irradiated with the laser beam can be performed with high precision while processing of the workpiece 12 is being stopped. Accordingly, when an operational state is switched from stopping of processing to processing, processing can be performed with high positional precision from the start.

The intensity of the laser beam 29, which has been reflected by the second polarizer 61, is about 1% of that of the laser beam introduced into the second polarizer 61. In other words, with reference to the laser beam 21, the intensity of the laser beam 29, which has been reflected by the second polarizer 61, is about 0.01% (=99%×1%×1%) of that of the laser beam 21. The workpiece 12 is irradiated with this laser beam 29 having been reflected by the second polarizer 61 through the condensing lens 31.

However, by presetting conditions so as not to exceed the threshold value for processing, for example, by changing field intensity applied to the optical device 9 so as to change the optical path to the optical path having a low light converging ability with respect to the target spot (second optical path), the workpiece 12 is not processed even when the workpiece 12 is irradiated with the laser beam 29 having been reflected by the second polarizer 61 and passed through the condensing lens 31 (S102). These steps of processing of the workpiece 12, stopping of processing of the workpiece 12, and the movement of the workpiece 12 with the stage 51 are continued until desired processing performed on the workpiece 12 is completed, and then the processing is ended.

In the present embodiment, the laser beam detected by the position sensor 81 has been split by the first polarizer 6 and the second polarizer 61, and accordingly, the intensity thereof can be set within the intensity range specified by the position sensor 81 regardless of the intensity of the laser beam with which the workpiece 12 is irradiated. In the present embodiment, the first polarizer 6 and the second polarizer 61 have the same characteristics with respect to the polarization extinction ratio. Accordingly, the intensity of the laser beam incident upon the position sensor 81 in the case where the workpiece 12 is irradiated with a high-intensity laser beam during processing is the same as that in the case where the workpiece 12 is irradiated with a low-intensity laser beam while processing is not performed. Thus, detection precision of the position sensor 81 can be maintained when processing is performed and when processing is not performed.

Furthermore, since the position sensor 81 detects the laser beam having passed through the first polarizer 6 and the second polarizer 61, effects such as air turbulence can be suppressed. That is, in the present embodiment, the position sensor 81 can be located at a position near the workpiece 12, and effects such as air turbulence can be minimized.

In the present embodiment, as described above, the intensity of the laser beam detected by the position sensor 81 can be set within the intensity range specified by the position sensor 81 when the workpiece 12 is processed and when the workpiece 12 is not processed, and detection by the position sensor 81 can be performed near the workpiece 12. As a result, the position irradiated with the laser beam can be more precisely changed or adjusted.

The mirror 91 can be located at a different position as long as the mirror 91 is located upstream of the position sensor 81 with respect to the path of the laser beam. Although the first polarizer 6 and the second polarizer 61 can have the same characteristics with respect to the polarization extinction ratio in the present embodiment, combination of the first polarizer 6 and the second polarizer 61 is not limited to this as long as the intensity of the laser beam incident upon the position sensor 81 is within the intensity range of the position sensor 81 when the workpiece 12 is processed and when the workpiece 12 is not processed. The above-described relationship between the P-wave and S-wave may be inverted.

A structure, in which the other workpiece 1a is irradiated with the laser beam, which is absorbed by the beam damper 10 in the present embodiment, is possible.

Light may pass through a fluorescent screen before it is incident upon the position sensor 81. The fluorescent screen emits fluorescence when the laser beam 25 having been transmitted through the second polarizer 61 strikes the fluorescent screen. The fluorescent screen causes the light having passed through a filter to be incident upon the position sensor 81. The fluorescent screen can be selected from a commercial fluorescent glass or a wavelength converting material having an appropriate excitation wavelength and an emission wavelength. The filter may have characteristics that allows fluorescence of a wavelength emitted by the fluorescent screen to pass therethrough and blocks the wavelength of the laser beam. The position sensor 81 detects the position of fluorescence having been emitted from the fluorescent screen and transmitted through the filter. When the light transmitted through the fluorescent screen is incident upon the position sensor 81, the position irradiated with the laser beam can be changed without changing the position sensor 81 even in the case where, for example, the intensity of the laser beam from the laser oscillator 4 is changed. Specifically, the intensity of the laser beam may be changed using the features of the laser oscillator 4 in the case where, for example, the workpiece 12 has a portion, which is to be processed under the conditions different from the conditions under which another portion of the workpiece 12 is to be processed. The intensity of the laser beam 25, which is transmitted through the second polarizer 61 and input to the position sensor 81, also changes in proportion to the intensity of the laser beam. In order to address this change in intensity, the laser beam 25 is caused to be incident upon the fluorescent screen before the laser beam 25 is incident upon the position sensor 81. By doing this, even when the intensity of the laser beam 25 incident upon the fluorescent screen is increased, fluorescence emitted from the fluorescent screen is saturated and light having a high intensity is not emitted. Thus, even when the intensity of the laser beam is increased by, for example, ten times, the intensity of the fluorescence remains at a certain threshold value and does not exceed an input limit of the position sensor 81. Accordingly, position detection can be performed.

### Fifth Embodiment

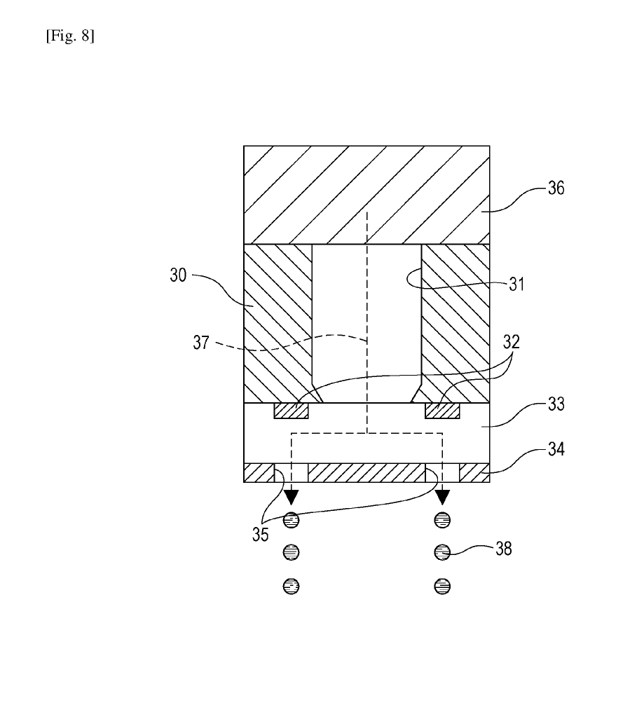

Next as a fifth embodiment, a method of fabricating a substrate is described, in which the substrate is fabricated using the laser processing apparatus and the method of processing with the laser described in the embodiments. In the present embodiment, an example is described, in which a substrate of an inkjet head is fabricated. FIG. 8 illustrates a section of a head unit of an inkjet printer.

In FIG. 8, a reference numeral 30 denotes a semiconductor substrate (inkjet head substrate), and a reference numeral 31 denotes a perpendicularly shaped groove defining a flow passage of ink. Heaters 32, a liquid chamber 33, an orifice plate 34, discharge ports 35, an ink tank 36, an ink path 37 indicated by a dashed line, and small ink droplets 38 are also illustrated in FIG. 8. The heaters 32 used to discharge ink, the liquid chamber 33, and the orifice plate 34 are formed in a lower surface of the semi-conductor substrate 30, in which the groove 31 is formed. The ink tank 36 that contains ink is attached to an upper surface of the semiconductor substrate 30. The ink reaches the heaters 32 from the ink tank 36 through the groove 31 and the liquid chamber 33. Bubbles formed by momentary heating and cooling of the ink using the heaters 32 push up the ink, thereby discharging the ink through the discharge ports 35 formed in the orifice plate 34 in the form of the small ink droplets 38.

In the present embodiment, the groove 31 is formed by laser processing as described in the aforementioned embodiments. The groove 31 defines a flow passage, through which the ink is supplied to the discharge ports 35 that allow the ink droplets 38 to be discharged therethrough. That is, the semiconductor substrate 30, in which the groove 31 has not been formed yet, as a workpiece is positioned on the stage and subjected to laser processing as described above. The semiconductor substrate 30 after laser processing can be used as is, or can be subjected to anisotropic etching in an alkaline etching solution for, for example, about 15 minutes so as to form a final shape of the groove 31.

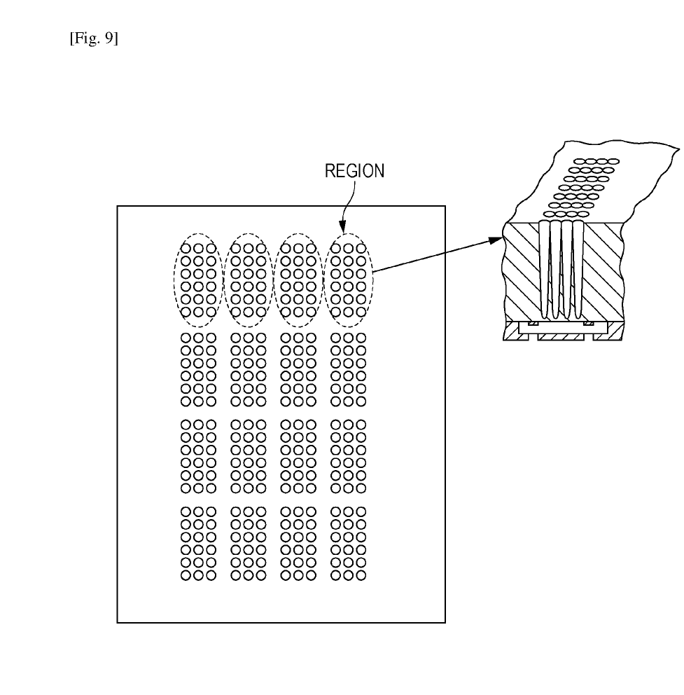

In the case where the groove 31 is formed by anisotropic etching, the semiconductor substrate 30 is irradiated with the laser beam so as to, as illustrated in FIG. 9, form a hole groups having a plurality of holes in a plurality of regions. The etching solution is caused to enter these hole groups, and the groove 31 defining a flow passage illustrated in FIG. 8, the flow passage being a passage through which the ink is supplied, is formed by anisotropic etching. By forming the hole groups, time required for anisotropic etching can be reduced, and the width of an ink supply port can be further reduced.

The inkjet head substrate is fabricated by processing, for example, a silicon material (workpiece) oriented in a (100) crystal plane. Heaters and electrical wiring, an etching stop layer, an etching protection film, and the like having etching resistance, a mechanism that discharges the ink, a mechanism for etching steps performed after laser processing, and so force are formed in the workpiece. The thickness of the workpiece is, for example, about 725 microns.

The diameter of the holes is preferably from 5 to 100 microns. The depth is preferably from 600 to 710 microns when the workpiece has a thickness of 725 microns.

A processing method using, for example, the first embodiment is described with reference to FIG. 1. The laser main beam is diverted to the optical device 9 side (first direction) by the polarizer 6. The control unit 8 controls the optical device 9 so that the optical device 9 becomes the first optical path, that is, an optical path having a high light converging ability with respect to the target spot, thereby converging the diverted laser main beam in one of the regions (first region; see the region illustrated in FIG. 9) on the workpiece 1 (substrate) so that the target spot is irradiated with the laser main beam. The stage 5, a galvanometer mirror, and the like are used to move a position irradiated with the laser main beam and the workpiece 1 (substrate) relative to each other, and a plurality of holes are formed in the first region, which is the one of the regions of the workpiece (substrate), thereby forming a hole group. At the same time as the hole group in the first region has been formed, the optical modulator 7 is controlled so as to change the polarization direction. The laser sub-beam is diverted to the optical device 9 side by the polarizer 6, and the control unit 8 controls the optical device 9 so that the optical device 9 is changed into the second optical path, that is, the optical path having a low light converging ability with respect to the target spot. Thus, with the laser processing apparatus set in a state in which the workpiece (substrate) is not processed by the laser sub-beam, the stage 5, the galvanometer mirror, and the like are used to move the position irradiated with the laser sub-beam and the workpiece (substrate) relative to each other to a region different from the first region (second region). After that, the optical modulator 7 is controlled again so as to change the polarization direction. The laser main beam is diverted to the optical device 9 side by the polarizer 6, and the control unit 8 controls the optical device 9 so that the optical device 9 is changed into the first optical path, that is, the optical path having a high light converging ability with respect to the target spot. The laser main beam is converged on the workpiece (substrate) so that the workpiece is irradiated with the laser main beam, and the stage 5, the galvanometer mirror, and the like are used to move the position irradiated with the laser sub-beam and the workpiece (substrate) relative to each other to the second region. The stage 5, the galvanometer mirror, and the like are used to move the position irradiated with the laser main beam and the workpiece (substrate) relative to each other, and a plurality of holes are formed in the second region, thereby forming a hole group. The above-described steps are repeated so as to form the hole groups, each of which is formed of the plurality of holes, in each region as illustrated in FIG. 9.

After that, the etching solution is caused to enter these hole groups, and the groove 31 defining a flow passage illustrated in FIG. 8, the flow passage being a passage through which the ink is supplied, is formed by anisotropic etching.

A processing method using the second embodiment is described with reference to FIG. 3. The laser main beam and the laser sub-beam are respectively diverted to the optical device 9 side (first direction) and the optical device 9a side (second direction) by the polarizer 6. The control unit 8 controls the optical device 9 so that the optical device 9 becomes the first optical path, that is, an optical path having a high light converging ability with respect to the target spot, thereby converging the diverted laser main beam in one of the regions (first region; see the region illustrated in FIG. 9) on the workpiece 1 (substrate) so that the target spot is irradiated with the laser main beam. The stage 5, the galvanometer mirror, and the like are used to move the position irradiated with the laser main beam and the workpiece 1 (substrate) relative to each other, and a plurality of holes are formed in the first region, which is the one of the regions of the workpiece 1 (substrate), thereby forming a hole group. In contrast, the control unit 8 controls the optical device 9a so that the optical device 9a is changed into the second optical path, that is, the optical path having a low light converging ability with respect to the target spot. Thus, with the laser processing apparatus set in a state in which the workpiece 1a (substrate) is not processed by the laser sub-beam, the stage 5a, the galvanometer mirror, and the like are used to move the position irradiated with the laser sub-beam and the workpiece 1a (substrate) relative to each other to a region (third region) of the workpiece 1a (substrate).

After the hole group in the first region has been formed, the optical modulator 7 is controlled so as to change the polarization direction. The laser sub-beam and the laser main beam are respectively diverted to the optical device 9 side and the optical device 9a side by the polarizer 6. The control unit 8 controls the optical device 9 so that the optical device 9 is changed into the second optical path, that is, the optical path having a low light converging ability with respect to the target spot. Thus, with the laser processing apparatus set in a state in which the workpiece 1 (substrate) is not processed by the laser sub-beam, the stage 5, the galvanometer mirror, and the like are used to move the position irradiated with the laser sub-beam and the workpiece 1 (substrate) relative to each other to a region (second region) different from the first region. The laser main beam having diverted to the optical device 9a side is converged on the workpiece 1a (substrate) via the optical device 9a that has been changed into the first optical path, so as to form the hole group in the third region.

After that, the optical modulator 7 is controlled again so as to change the polarization direction. The laser main beam and the laser sub-beam are respectively diverted to the optical device 9 side and the optical device 9a side by the polarizer 6. The control unit 8 controls the optical device 9 so that the optical device 9 is changed into the first optical path, that is, the optical path having a high light converging ability with respect to the target spot. The laser main beam is converged on the workpiece 1 (substrate) so that the workpiece 1 is irradiated with the laser main beam, and the stage 5, the galvanometer mirror, and the like are used to move the position irradiated with the laser sub-beam and the workpiece 1 (substrate) relative to each other, thereby forming the plurality of holes in the second region so as to form the hole group. In contrast, the control unit 8 controls the optical device 9a so that the optical device 9a is changed into the second optical path, that is, the optical path having a low light converging ability with respect to the target spot. Thus, with the laser processing apparatus set in a state in which the workpiece 1a is not processed by the laser sub-beam, the stage 5a, the galvanometer mirror, and the like are used to move the position irradiated with the laser sub-beam and the workpiece 1a (substrate) relative to each other to a region (fourth region) of the workpiece 1a (substrate).

By repeating the above-described steps, the hole groups, each of which is formed of the plurality of holes, can be formed in each region of two workpieces (substrates) at a time.

As described in the third embodiment, processing using the optical path having an intermediate light converging ability can be similarly performed.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Applications No. 2011-248382, filed Nov. 14, 2011, and No. 2011-248383, filed Nov. 14, 2011, which are hereby incorporated by reference herein in their entirety.

1. A laser processing apparatus comprising:
a laser oscillator;
a polarization direction switching member that switches a polarization direction of a laser beam emitted from the laser oscillator;
a splitting member that splits the laser beam in accordance with the polarization direction having been switched by the polarization direction switching member;
a light converging ability changing member that changes a light converging ability of the laser beam, the laser beam being split by the splitting member; and
a control unit that controls the polarization direction switching member and the light converging ability changing member in accordance with a state in which processing is being performed on the workpiece.

2. The laser processing apparatus according to claim 1,
wherein the polarization direction switching member switches the polarization direction of the laser beam between a first polarization direction and a second polarization direction,
wherein the splitting member diverts the laser beam mainly in a first diverting direction when the polarization direction switching member switches the polarization direction to the first polarization direction and diverts the laser beam mainly in a second diverting direction when the polarization direction splitting member switches the polarization direction to the second polarization direction,
wherein the light converging ability changing member changes an optical path, the laser beam having been diverted in the first diverting direction by the splitting member passing through the optical path, between an optical path having a high light converging ability with respect to a target spot of the workpiece and an optical path having a low light converging ability with respect to the target spot of the workpiece, and
wherein the control unit is able to execute a first mode and a second mode, the control unit causing the polarization direction switching member to switch the polarization direction to the first polarization direction and the light converging ability changing member to become the optical path having a high light converging ability with respect to the target spot in the first mode, and the control unit causing the polarization direction switching member to switch the polarization direction to the second polarization direction and the light converging ability changing member to become the optical path having a low light converging ability with respect to the target spot in the second mode.

3. The laser processing apparatus according to claim 2, further comprising:
a beam damper that absorbs the laser beam having been diverted in the second diverting direction by the splitting member.

4. The laser processing apparatus according to claim 2, further comprising:
a mirror that reflects the laser beam having been diverted in the second diverting direction by the splitting member; and
another light converging ability changing member controlled by the control unit, the other light converging ability changing member changing the optical path, the laser beam reflected by the minor passing through the optical path, between the optical path having a high light converging ability with respect to the target spot of the workpiece and the optical path having a low light converging ability with respect to the target spot of the workpiece,
wherein the control unit causes the other light converging ability changing member to become the optical path having a low light converging ability with respect to the target spot in the first mode and causes the other light converging ability changing member to become the optical path having a high light converging ability with respect to the target spot in the second mode.

5. The laser processing apparatus according to claim 2,
wherein the control unit causes the light converging ability changing member to become an optical path having an intermediate light converging ability.

6. The laser processing apparatus according to any one of claim 1,
wherein the light converging ability changing member is a refractive index modulator that causes a refractive index of light passing therethrough to change in accordance with field intensity.

7. A laser processing apparatus comprising:
a laser oscillator;
a polarization direction switching member that switches a polarization direction of a laser beam emitted from the laser oscillator;
a first splitting member that splits the laser beam in accordance with the polarization direction having been switched by the polarization direction switching member;
a second splitting member that splits the laser beam having been split by the first splitting member into a first split laser beam and a second split laser beam;
a position sensor upon which the first split laser beam is incident so as to detect a position of the laser beam;
a condensing lens that converges the second split laser beam on a workpiece so as to cause the workpiece to be irradiated with the second split laser beam; and
a unit configured to change an irradiation position that changes a position irradiated with the second split laser beam in accordance with the position of the laser beam detected by the position sensor.

8. The laser processing apparatus according to claim 7,
wherein the unit configured to change an irradiation position includes at least one of a unit configured to move a mirror, a unit configured to change a light converging ability of a light converging ability changing member, and a unit configured to move the condensing lens.

9. The laser processing apparatus according to claim 7,
wherein the first split laser beam is transmitted through a fluorescent screen before the first split laser beam is incident upon the position sensor.

10. A method of processing with laser, the method comprising the steps of:
switching a polarization direction of a laser beam emitted from a laser oscillator;
splitting the laser beam in accordance with the polarization direction having been switched by the switching of the polarization direction; and
changing a light converging ability of the laser beam, the laser beam being split by the splitting,
wherein the polarization direction of the laser beam is switched and the light converging ability of the laser beam is changed in accordance with a state in which processing is being performed on a workpiece.

11. The method according to claim 10,
wherein the switching of the polarization direction switches the polarization direction of the laser beam between a first polarization direction and a second polarization direction,
wherein the splitting splits the laser beam mainly in a first diverting direction when the switching of the polarization direction switches the polarization direction to the first polarization direction and diverts the laser beam mainly in a second diverting direction when the switching of the polarization direction switches the polarization direction to the second polarization direction,
wherein the changing of the light converging ability changes an optical path, the laser beam having been diverted in the first diverting direction by the splitting passing through the optical path, between an optical path having a high light converging ability with respect to a target spot of the workpiece and an optical path having a low light converging ability with respect to the target spot of the workpiece, and
wherein a first mode and a second mode are executable, the switching of the polarization direction switching the polarization direction to the first polarization direction and the changing of the light converging ability changing the optical path into the optical path having a high light converging ability with respect to the target spot in the first mode, and the switching of the polarization direction switching the polarization direction to the second polarization direction and changing of the light converging ability changing the optical path to the optical path having a low light converging ability with respect to the target spot in the second mode.

12. The method according to claim 10,
wherein the changing of the light converging ability changes the optical path into an optical path having an intermediate light converging ability.

13. The method according to claim 11, further comprising the steps of:
reflecting the laser beam having been diverted in the second diverting direction by the splitting; and
performing another changing of the light converging ability that changes the optical path, the laser beam reflected by the reflecting passing through the optical path, between the optical path having a high light converging ability with respect to the target spot of the workpiece and the optical path having a low light converging ability with respect to the target spot of the workpiece,
wherein performing of the other changing of the light converging ability changes the optical path into the optical path having a low light converging ability with respect to the target spot in the first mode and performing of the other changing of the light converging ability changes the optical path into the optical path having a high light converging ability with respect to the target spot in the second mode.

14. The method according to claim 11 further comprising the steps of:
reflecting the laser beam having been diverted in the second diverting direction by the splitting; and
performing another changing of the light converging ability that changes the optical path, the laser beam reflected by the reflecting passing through the optical path, among the optical path having a high light converging ability with respect to the target spot of the workpiece, the optical path having a low light converging ability with respect to the target spot of the workpiece, and an optical path having an intermediate light converging ability with respect to the target spot of the workpiece.

15. A method of processing with laser, the method comprising the steps of:
switching a polarization direction of a laser beam emitted from a laser oscillator;
performing a first splitting of the laser beam in accordance with the polarization direction having been switched by the switching of the polarization direction;
performing a second splitting that further splits one of the laser beams having been split by the first splitting, the one of the laser beams being split into a first split laser beam and a second split laser beam;
detecting a position of the laser beam in accordance with the first split laser beam;
changing a position irradiated with the second split laser beam in accordance with the position of the laser beam having been detected.

16. The method according to claim 15,
wherein the position irradiated with the second split laser beam is changed by performing at least one of moving of a minor, changing of a light converging ability of a light converging ability changing member, and moving of a condensing lens.

17. A method of fabricating a substrate by processing a workpiece, the method comprising the step of:
laser processing the workpiece, wherein the laser processing includes the steps of switching a polarization direction of a laser beam emitted from a laser oscillator, splitting the laser beam in accordance with the polarization direction having been switched by the switching of the polarization direction, and
changing a light converging ability of the laser beam, the laser beam being split by the splitting,
wherein the polarization direction of the laser beam is switched and the light converging ability of the laser beam is changed in accordance with a state in which processing is being performed on the workpiece.

18. The method according to claim 17,
wherein the switching of the polarization direction switches the polarization direction of the laser beam between a first polarization direction and a second polarization direction,
wherein the splitting diverts the laser beam mainly in a first diverting direction when the switching of the polarization direction switches the polarization direction to the first polarization direction and diverts the laser beam mainly in a second diverting direction when the switching of the polarization direction switches the polarization direction to the second polarization direction,
wherein the changing of the light converging ability changes an optical path, the laser beam having been diverted in the first diverting direction by the splitting passing through the optical path, between an optical path having a high light converging ability with respect to a target spot of the workpiece and an optical path having a low light converging ability with respect to the target spot of the workpiece,
wherein a portion of the workpiece subjected to laser processing is irradiated with the laser beam, the polarization direction of the laser beam having been switched to the first polarization direction by switching of the polarization direction, the optical path, the laser beam passing through the optical path, having been changed to the optical path having a high light converging ability with respect to the target spot by the changing of the light converging ability, and wherein a portion of the workpiece not subjected to laser processing is irradiated with the laser beam, the polarization direction of the laser beam having been switched to the second polarization direction by switching of the polarization direction, the optical path, the laser beam passing through the optical path, having been changed to the optical path having a low light converging ability with respect to the target spot by the changing of the light converging ability.

19. The method according to claim 18,
wherein the portion of the workpiece not subjected to laser processing is irradiated with the laser beam passing through an optical path having an intermediate light converging ability.

20. A method of fabricating an inkjet head, the inkjet head having an ink flow passage being made by forming hole groups each having a plurality of holes formed in a plurality of regions of a substrate using processing with a laser beam, wherein the processing with the laser beam includes the steps of:
forming a hole group having a plurality of holes by splitting the laser beam into a laser main beam and a laser sub-beam, diverting the laser main beam in a first direction and laser sub-beam in a second direction, and converging the laser main beam having been diverted in the first direction on a first region of the substrate,
moving the substrate and a position irradiated with the laser sub-beam relative to each other so that the position irradiated with the laser sub-beam is in a second region of the substrate by changing a polarization direction of the laser beam so as to divert the laser main beam in the second direction and the laser sub-beam in the first direction, and changing an optical path, the laser sub-beam having been diverted in the first direction passing through the optical path, and
forming another hole group having a plurality of holes by changing the polarization direction of the laser beam so as to divert the laser main beam in the first direction and the laser sub-beam in the second direction, and converging the laser main beam having been diverted in the first direction on a second region of the substrate.

21. The method according to claim 20,
wherein a third region is irradiated with the laser main beam diverted in the second direction so as to form another hole group having a plurality of holes.

22. The method according to claim 20,
wherein the optical path is changed by a refractive index modulator that causes a refractive index of light passing therethrough to change in accordance with field intensity.
